(19) United States
(12) Patent Application Publication
(10) Pub. No.: US 2015/0219956 A1
(43) Pub. Date: Aug. 6, 2015

(54) LIGHT SWITCHING MODULE

(71) Applicant: BENQ MATERIALS CORPORATION, Taoyuan County (TW)

(72) Inventor: Cyun-Tai HONG, New Taipei City (TW)

(21) Appl. No.: 14/584,103

(22) Filed: Dec. 29, 2014

(30) Foreign Application Priority Data
Feb. 6, 2014 (TW) 103103908

(51) Int. Cl. G02F 1/1335; G02F 1/13363

(52) U.S. Cl. CPC G02F 1/133504; G02F 1/133528; G02F 1/133526; G02F 1/13363

(57) ABSTRACT

Disclosed is a light switching module comprising a polarizing element for transforming incident light to polarized light; a liquid crystal cell disposed on the polarizing element; and a scattering element with a substrate and a birefringence layer disposed on the liquid crystal cell; wherein the light switching module appears transparent state or scattering state after the incident light transmitting the light switching module.

### CROSS-REFERENCE TO RELATED APPLICATION

This application claims the benefit of Taiwan Patent Application No.103103908, filed on Feb. 6, 2014, in the Taiwan Intellectual Property Office, the disclosure of which is incorporated herein in its entirety by reference.

### BACKGROUND

1. Technical Field

The present invention relates to a light switching module for switching the state of the incident light to transparent state or scattering state according to the principle of light refraction.

2. Description of Related Art

With the developments of the smart glass and smart window, various applications of light adjusting device or light switching device are thereby on the increase. The technical principle of conventional electronically controlled liquid crystal type smart windows is to sandwich polymer-dispersed liquid crystals between two sheets of glass, and to control the alignment directions of the liquid crystals of ordered or disordered arrangement with electric field for adjusting the transmittance. The polymer-dispersed liquid crystals are liquid crystal droplets dispersed into a polymer matrix; however, it usually has a problem of uneven dispersion of the liquid crystals.

### SUMMARY OF THE INVENTION

Accordingly, the present disclosure is to provide a novel, inventive and useful light switching module for switching the transmitting light to transparent state or scattering state.

An aspect of the present disclosure is to provide a light switching module comprising a polarizing element for transforming incident light to polarized light; a liquid crystal cell disposed on the polarizing element, comprising two transparent substrates, and liquid crystals interposed therebetween for controlling the polarization direction of the polarized light; and a scattering element disposed on the liquid crystal cell, comprising a substrate with a refractive index comprising a plurality of scattering micro lenses on a side thereof, wherein the plurality of scattering micro lenses are arranged parallelly and perpendicularly to the polarization direction of the polarized light transformed by the polarizing element in two-dimensional directions; and a birefringent layer disposed on the plurality of scattering micro lenses of the substrate, the birefringent layer having an extraordinary refractive index (nₑ) parallel to direction of optical axis of the birefringent layer and an ordinary refractive index (nₒ) perpendicular to direction of optical axis of the birefringent layer; wherein the refractive index of the substrate is the same as one of the extraordinary refractive index and the ordinary refractive index of the birefringent layer.

In a light switching module of a preferred embodiment of the present invention, the liquid crystal cell is a vertical alignment cell or twisted nematic cell.

In a light switching module of another preferred embodiment of the present invention, the plurality of scattering micro lenses include two-dimensional concave-convex micro lenses of ordered or disordered arrangement.

In a light switching module of another preferred embodiment of the present invention, the plurality of scattering micro lenses are selected from the group consisting of spherical micro lenses, aspherical micro lenses, micro prisms, rough surface structures and a combination thereof.

In a light switching module of another preferred embodiment of the present invention, the cross-sectional shape of the scattering micro lenses is selected from the group consisting of polygons, semi-circular, semi-elliptical, irregular shape and a combination thereof.

In a light switching module of another preferred embodiment of the present invention, the pitch of the scattering micro lenses is in a range of 0 μm to 1000 μm ; the width of each of the scattering micro lens is in a range of 10 μm to 1000 μm; the height of each of the scattering micro lens is in a range of 10 μm to 1000 μm.

In a light switching module of another preferred embodiment of the present invention, the material of the birefringent layer is liquid crystal, birefringent crystal or birefringent resin.

In a light switching module of another preferred embodiment of the present invention, the polarizing element is selected from the group consisting of an absorption-type polarizer, a reflection-type polarizer, a dyeing-type polarizer, a coatable polarizer, a wire-grid polarizer and a combination thereof.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a perspective view of the light switching module of an aspect of the present invention;

FIG. 2 is a perspective view illustrating the optical path of the scattering element of the light switching module of an embodiment of the present invention;

FIG. 3 is a perspective view illustrating different cross-sectional shapes of the scattering micro lenses of the light switching module of a preferred embodiment of the present invention;

FIG. 4 is a perspective view illustrating the scattering element of the light switching module of another embodiment of the present invention.

### DESCRIPTION OF EMBODIMENTS OF THE INVENTION

To describe the technical features of the present invention in greater detail, preferred embodiments of the present invention are provided below along with the accompanied drawings accordingly as follows. The various embodiments will be described in detail with reference to the accompanying drawings. References made to particular examples and implementations are for illustrative purposes, and are not intended to limit the scope of the invention or the claims.

The light switching module of the present invention will be described along with the accompanied drawings accordingly as follows. It is appreciated that the same reference numbers will be used throughout the drawings to refer to the same or like parts.

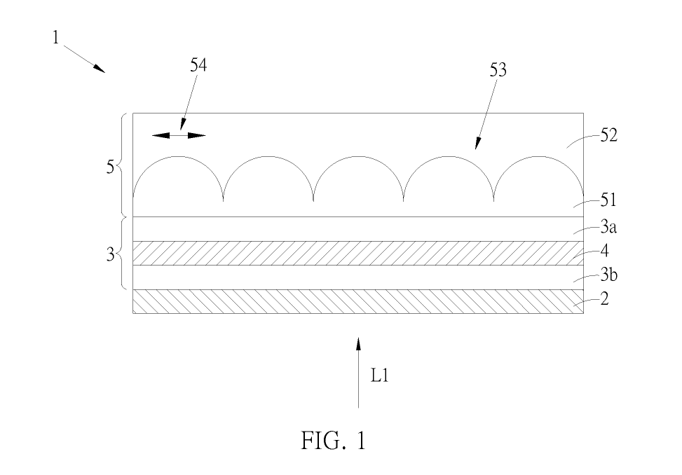

Referring to FIG. 1, an aspect of the present disclosure is to provide a light switching module 1 comprising a polarizing element 2 for transforming incident light L1 to polarized light; a liquid crystal cell 3 disposed on the polarizing element 2, comprising two transparent substrates 3a-3b, and liquid crystals 4 interposed therebetween for controlling the polarization direction of the polarized light; and a scattering element 5 disposed on the liquid crystal cell 3, comprising a substrate 51 with a refractive index comprising a plurality of scattering micro lenses 53 on a side thereof, wherein the plurality of scattering micro lenses 53 are arranged parallelly and perpendicularly to the polarization direction of the polarized light transformed by the polarizing element 2 in two-dimensional directions; and a birefringent layer 52 disposed on the plurality of scattering micro lenses 53 of the substrate 51, the birefringent layer having an extraordinary refractive index (nₑ) parallel to direction of optical axis 54 of the birefringent layer 52 and an ordinary refractive index (nₒ) perpendicular to direction of optical axis 54 of the birefringent layer 52; wherein the refractive index of the substrate 51 is the same as one of the extraordinary refractive index and the ordinary refractive index of the birefringent layer 52.

In another aspect of the present disclosure, the scattering element 5 is optionally adjacent to the liquid crystal cell 3 with the substrate 51 or the birefringent layer 52.

In a light switching module of a preferred embodiment of the present invention, the liquid crystal cell is a vertical alignment cell or twisted nematic cell; so as to rotate the polarization direction of the polarized light parallel or perpendicular to the direction of the optical axis of the birefringent layer according to necessity.

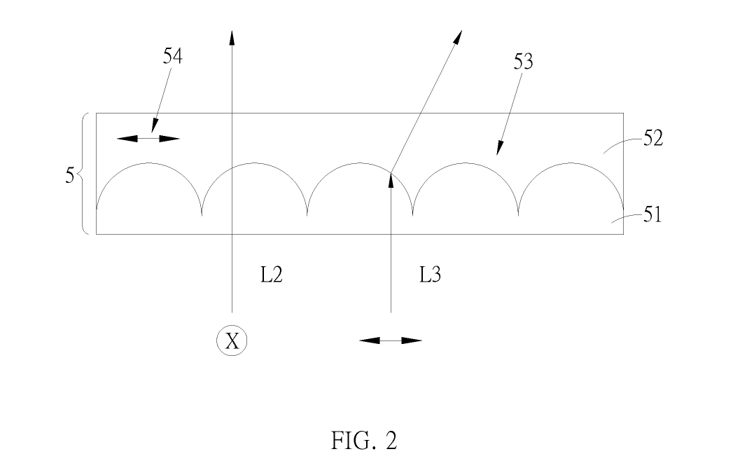

Referring to FIG. 2, FIG. 2 is a perspective view illustrating the optical path of the scattering element 5 of the light switching module of an embodiment of the present invention. In condition that the refractive index of the substrate 51 and the ordinary refractive index of birefringent layer 52 are the same, the incident light L2 perpendicular to the direction of optical axis 54 of the birefringent layer 52 can only induce the same ordinary refractive index of the substrate 51 and the birefringent layer 52; the substrate 51 and the birefringent layer 52 are as the same media of the same refractive index for the incident light L2; therefore, the light switching module appears transparent state and without refraction phenomenon occurred at the interface of the substrate 51 and the birefringent layer 52; in condition that the incident light L3 is switched to the direction parallel to the direction of optical axis 54 of the birefringent layer 52 by the liquid crystal cell, the incident light L3 can induce the extraordinary refractive index of the birefringent layer 52, and the substrate 51 and the birefringent layer 52 are different media of different refractive index for the incident light L3, and the incident light L3 cannot directly transmit the plurality of scattering micro lenses 53 of the scattering element 5; therefore, the light switching module appears scattering state with refraction phenomenon occurred at the interface of the substrate 51 and the birefringent layer 52.

In a light switching module of a preferred embodiment of the present invention, the plurality of scattering micro lenses include two-dimensional concave-convex micro lenses of ordered or disordered arrangement for scattering the incident light of different directions and enhancing the effect and uniformity of the scattering state.

In a light switching module of a preferred embodiment of the present invention, the plurality of scattering micro lenses are selected from the group consisting of spherical micro lenses, aspherical micro lenses, micro prisms, rough surface structures and a combination thereof.

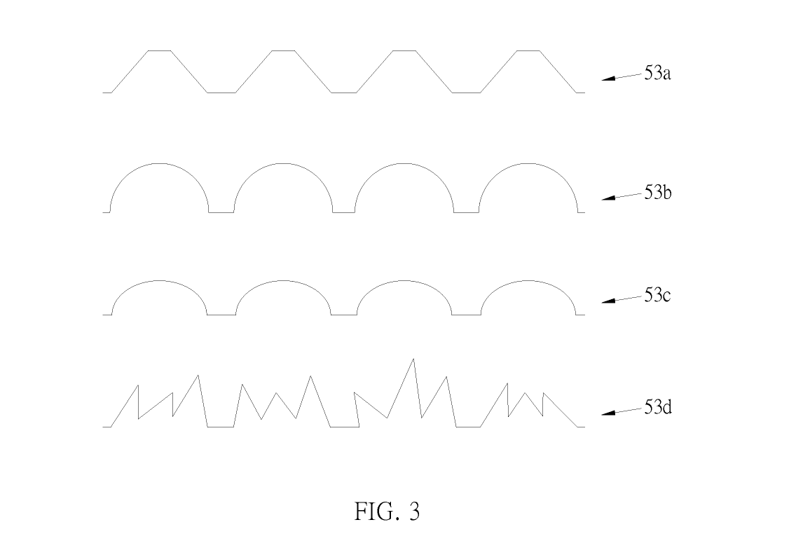

Referring to FIG. 3, in a light switching module of a preferred embodiment of the present invention, the cross-sectional shape of the scattering micro lenses is selected from the group consisting of polygons 53a, semi-circular 53b, semi-elliptical 53c, irregular shape 53d and a combination thereof.

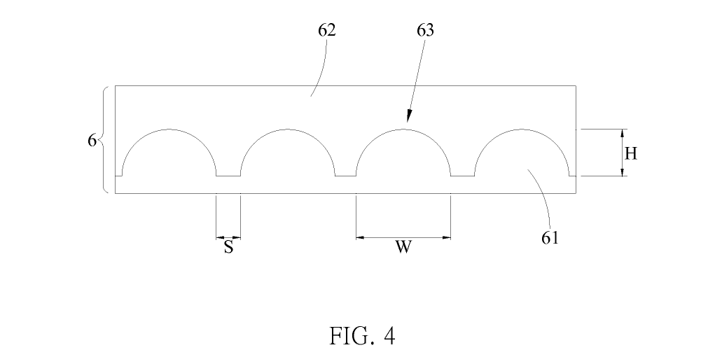

Referring to FIG. 4, FIG. 4 is a perspective view illustrating the scattering element 6 of the light switching module of another embodiment of the present invention. The pitch S of the scattering micro lenses 63 between the substrate 61 and the birefringent layer 62 is in a range of 0 μm to 1000 μm; the width W of each of the scattering micro lens 63 is in a range of 10 μm to 1000 μm; the height H of each of the scattering micro lens 63 is in a range of 10 μm to 1000 μm.

In a light switching module of a preferred embodiment of the present invention, the material of the birefringent layer is liquid crystal, birefringent crystal or birefringent resin.

In a light switching module of a preferred embodiment of the present invention, the polarizing element is selected from the group consisting of an absorption-type polarizer, a reflection-type polarizer, a dyeing-type polarizer, a coatable polarizer, a wire-grid polarizer and a combination thereof.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemlary embodiments described therein.

What is claimed is:

1. A light switching module comprising:
a polarizing element for transforming incident light to polarized light;
a liquid crystal cell disposed on the polarizing element, comprising two transparent substrates, and liquid crystals interposed therebetween for controlling the polarization direction of the polarized light; and
a scattering element disposed on the liquid crystal cell, comprising a substrate with a refractive index comprising a plurality of scattering micro lenses on a side thereof, wherein the plurality of scattering micro lenses are arranged parallelly and perpendicularly to the polarization direction of the polarized light transformed by the polarizing element in two-dimensional directions; and
a birefringent layer disposed on the plurality of scattering micro lenses of the substrate, the birefringent layer having an extraordinary refractive index parallel to direction of optical axis of the birefringent layer and an ordinary refractive index perpendicular to direction of optical axis of the birefringent layer; wherein the refractive index of the substrate is the same as one of the extraordinary refractive index and the ordinary refractive index of the birefringent layer.

2. The light switching module according to claim 1, wherein the liquid crystal cell is a vertical alignment cell or twisted nematic cell.

3. The light switching module according to claim 1, wherein the plurality of scattering micro lenses include two-dimensional concave-convex micro lenses of ordered or disordered arrangement.

4. The light switching module according to claim 1, wherein the plurality of scattering micro lenses are selected from the group consisting of spherical micro lenses, aspherical micro lenses, micro prisms, rough surface structures and a combination thereof.

5. The light switching module according to claim 1, wherein the cross-sectional shape of the scattering micro lenses is selected from the group consisting of polygons, semi-circular, semi-elliptical, irregular shape and a combination thereof.

6. The light switching module according to claim 1, wherein the pitch of the scattering micro lenses is in a range of 0 μm to 1000 μm.

7. The light switching module according to claim 1, wherein the width of each of the scattering micro lens is in a range of 10 μm to 1000 μm.

8. The light switching module according to claim 1, wherein the height of each of the scattering micro lens is in a range of 10 μm to 1000 μm.

9. The light switching module according to claim 1, wherein the material of the birefringent layer is liquid crystal, birefringent crystal or birefringent resin.

10. The light switching module according to claim 1, wherein the polarizing element is selected from the group consisting of an absorption-type polarizer, a reflection-type polarizer, a dyeing-type polarizer, a coatable polarizer, a wire-grid polarizer and a combination thereof.
